(19) United States
(12) Patent Application Publication
(10) Pub. No.: US 2005/0013429 A1
(43) Pub. Date: Jan. 20, 2005

(54) Method and apparatus for replicating an answering machine to defeat telemarketing systems

(76) Inventor: Robert M. Bensman, Bay Village, OH (US)

Correspondence Address: Ray L. Weber;Renner, Kenner, Greive,, Bobak, Taylor & Weber, First National Tower, Fourth Floor, Akron, OH, 44308-1456, US

(21) Appl. No.: 10/618,382

(22) Filed: Jul. 14, 2003

(51) Int. Cl. H04M 1/00; H04M 3/00

(52) U.S. Cl. 379/377; 379/379

(57) ABSTRACT

A method and apparatus for defeating a predictive dialing telemarketing system includes an audio energy generator (18) that is capable of creating an electrical signal that replicates the audio energy associated with the message of an answering machine. The output of the audio energy generator is passed through an amplifier (22) and passed to a telephone line (16) by a controller (12) sensing that an in-coming call has been received. A predictive dialing telemarketing system recognizes the signal coupled to the telephone line as that of an answering machine and immediately disconnects.

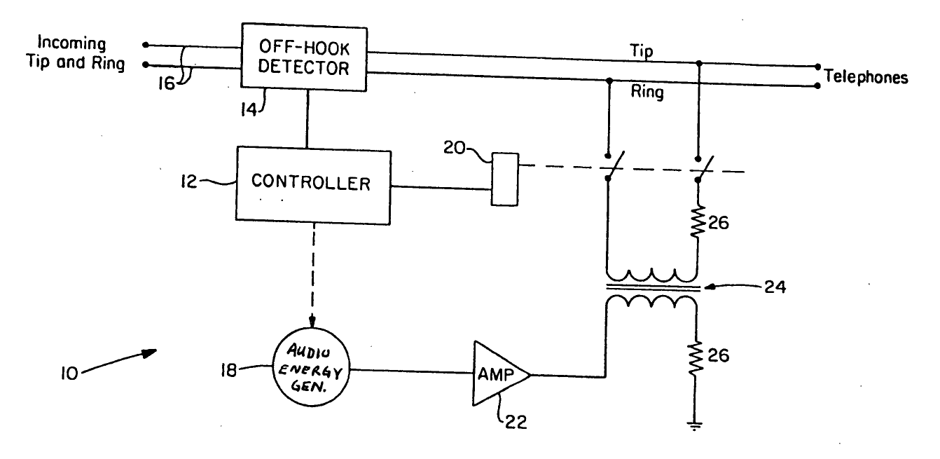

### TECHNICAL FIELD

The invention herein relates to the field of telephony and, more particularly, to a method and apparatus for defeating predictive dialing telemarketing systems. Specifically, the invention relates to a method and apparatus for automatically terminating phone calls placed by a predictive dialer by sending a signal of sufficient audio energy to replicate an answering machine when the telephone receiving the call is taken off the hook.

### BACKGROUND OF THE INVENTION

Reference is made to my prior U.S. Pat. No. 5,920,623 and its statements of the problems incident to telemarketing calls and its solution to the same. In that prior patent, when a telephone call was received, a Special Information Tone (SIT), indicating a non-working number, was coupled to the telephone line. Immediately upon receiving the SIT signal, the predictive dialer disconnected and removed the number from its library. The use of other SIT tones was also contemplated by the invention.

It has become apparent that not all predictive dialers are responsive to SIT signals and, accordingly, the system set forth in my prior U.S. Pat. No. 5,920,623 may not be capable of defeating such predictive dialers.

It has further become known that many predictive dialers are capable of determining whether a live person or an answering machine has been reached when a phone call is placed. Typically, an individual answers the phone with a very short greeting such as “hello” or the like. To the contrary, answering machines answer the phone with a rather substantial burst of communication, identifying the individual or phone number reached, apologizing for the unavailability of the individual associated with the telephone number, and giving detailed instructions as to the procedure to follow to leave a message. For this reason, many telemarketing systems have associated “total audio energy detection systems,” that serve to sense the total audio energy received immediately following the phone being “answered.” If the audio energy received in a short time span (2-4 seconds or the like) exceeds a threshold level associated with the fact an individual has answered the phone, the predictive dialer determines that it is connected to an answering machine and the phone call is terminated.

Thus, it is desirable to provide a method and apparatus for generating the replication of an answering machine to be connected to a telephone line for all incoming calls to an individual's telephone number, thereby causing any predictive dialing telemarketing system to disconnect the call upon answering.

### SUMMARY OF INVENTION

In view of the foregoing, it is an aspect of the invention to provide a method and apparatus for defeating a predictive dialing telemarketing system.

Another aspect of the invention is to provide a method and apparatus for defeating a predictive dialing telemarketing system that includes the replication of an answering machine to deceive such a system into believing that it has reached an answering machine.

Still a further aspect of the invention is to provide a method and apparatus for defeating a predictive dialing telemarketing system that conforms to FCC and local telephone company standards.

It is yet another aspect of the invention to provide a method and apparatus for defeating a predictive dialing telemarketing system that can be incorporated into present phone systems in various ways.

The foregoing and other aspects of the invention are achieved by an apparatus for defeating a predictive dialing telemarketing system that includes an audio energy generator that generates signals substantially similar to those associated with the greeting message of an answering machine used in association with a controller that sends such signals to all incoming calls.

Other aspects of the invention are attained by an apparatus interposed in a telephone line for defeating predictive dialing telemarketing systems, comprising: an off-hook detector connected to the telephone line; an audio energy generator producing a signal imitating the energy associated with an answering machine greeting; a switch interposed between said audio energy generator and the telephone; and a controller interposed between said off-hook detector and said switch for activating said switch to interconnect said audio energy generator to said phone line upon receipt of an incoming call.

Still other aspects of the invention are attained by a method for defeating predictive dialing telemarketing systems, comprising: sensing an incoming call on a telephone line; generating a signal imitating the energy associated with an answering machine greeting; and placing said signal upon said telephone line each time an incoming call is sensed.

### BRIEF DESCRIPTION OF THE DRAWINGS

For a complete understanding of the objects, techniques, and structure of the invention, reference should be made to the following detailed description and accompanying drawing wherein a schematic diagram of the apparatus used to accomplish the invention is shown.

### PREFERRED EMBODIMENT FOR CARRYING OUT THE INVENTION

An apparatus for defeating a predictive dialing telemarketing system is depicted generally in the drawing by the numeral 10. The system 10 includes a controller 12 that is in communication with an off-hook detector 14 that is in communication with the incoming and outgoing telephone line 16 of the telephone system. The apparatus 10 also includes an audio energy generator 18 that is capable of creating signals that imitate the audio energy associated with a typical greeting employed with an answering machine. In the embodiment of the invention depicted in the drawing, the audio energy generator 18 might comprise a short duration of musical tones, actual voice text, or the like. In the music or sound pattern embodiment, it is contemplated the sound pattern is distinctive, pleasant, and optimized to overflow a total audio energy detection system associated with a predictive dialer in the shortest time possible.

In general, the system 10 functions by sending an output from the audio energy generator 18 onto the phone line 16 whenever a telephone is taken off hook. This is accomplished when the off-hook detector 14 detects that an incoming call has been received and the phone line has been connected. The controller 12 receives the signal from the off-hook detector 14 and takes the steps or performs the functions necessary to send the signals produced by the audio energy generator 18 into the phone line 16. By doing so, most predictive dialing telemarketing systems calling the number will receive the audio energy and disconnect and terminate the call.

In one embodiment of the invention, the controller 12 sends the signals from the audio energy generator 18 onto the phone line 16 by activating a relay 20 that connects the signal directly to the phone line 16. The generator 18 may be connected to an amplifier 22 such that the signal produced by the generator 18 may be amplified to a level that replicates an answering machine greeting. The amplifying signal may then be transformed by a transformer 24 before it is sent to the phone line 16 so that the apparatus 10 conforms with all FCC and telephone system regulations.

In one embodiment of the invention, the apparatus 10 may operate such that the audio energy generator is constantly operating and generating the associated output signals, but such signals are only connected to the phone line 16 when the controller 12 closes the relay 20. In another embodiment, the controller 12 may actually engage the audio energy generator 18 as by the dashed lines shown in the drawing to generate the audio energy signals only on demand. Of course, in either embodiment, the controller 12 only effects connection of the audio energy generator 18 to the phone line 16 with respect to incoming calls, not outgoing calls.

Thus it can be seen that the objects of the invention have been satisfied by the structure presented above. While in accordance with the patent statutes only the best mode and preferred embodiment of the invention has been presented and described in detail, the invention is not limited thereto or thereby. Accordingly, for an appreciation of the true scope and breadth of the invention, reference should be made to the following claims.

1. An apparatus interposed in a telephone line for defeating predictive dialing telemarketing systems, comprising:
an off-hook detector connected to the telephone line;
an audio energy generator producing a signal imitating the energy associated with an answering machine greeting;
a switch interposed between said audio energy generator and the telephone; and
a controller interposed between said off-hook detector and said switch for activating said switch to interconnect said audio energy generator to said phone line upon receipt of an incoming call.

2. The apparatus for defeating predictive dialing telemarketing systems according to claim 1, wherein said audio energy generator continually produces said signal.

3. The apparatus for defeating predictive dialing telemarketing systems according to claim 1, wherein said controller is interconnected with said audio energy generator, said controller activating said audio energy generator to produce said signal upon receipt of said incoming call.

4. A method for defeating predictive dialing telemarketing systems, comprising:
sensing an incoming call on a telephone line;
generating a signal imitating the energy associated with an answering machine greeting; and
placing said signal upon said telephone line each time an incoming call is sensed.

5. The method for defeating predictive dialing telemarketing systems according to claim 4, wherein said signal is continuously generated.

6. The method for defeating predictive dialing telemarketing systems according to claim 4, wherein said signal is generated upon said sensing of an incoming call.
